(19) United States
(12) Patent Application Publication
(10) Pub. No.: US 2026/0212470 A1
(43) Pub. Date: Jul. 23, 2026

(54) NEURAL NETWORK BASED METHOD FOR TONE MAPPING

(71) Applicant: SAMSUNG ELECTRONICS CO., LTD., Suwon-si (KR)

(72) Inventors: Doron SABO, Tel-Aviv (IL); Lital SHANI-ZERBIB, Tel-Aviv (IL); Roee SFARADI, Tel-Aviv (IL); Sapir KONTENTE, Tel-Aviv (IL); Shachar PRAISLER, Tel-Aviv (IL); Stas DUBINCHIK, Tel-Aviv (IL); Roy YAM, Tel-Aviv (IL)

(73) Assignee: SAMSUNG ELECTRONICS CO., LTD., Suwon-si (KR)

(21) Appl. No.: 19/029,479

(22) Filed: Jan. 17, 2025

(51) Int. Cl. G06T 5/92; G06V 10/82

(52) U.S. Cl. CPC G06T 5/92; G06V 10/82; G06T 2207/20208

(57) ABSTRACT

A method and device for performing tone mapping, including: obtaining an input image and at least one tuning parameter corresponding to the input image; obtaining a plurality of input pixel values corresponding to the input image; generating a plurality of tone mapping curves by providing the plurality of input pixel values and the at least one tuning parameter to a plurality of first neural network models; calculating a plurality of weight factors by providing the plurality of input pixel values and the at least one tuning parameter to a second neural network model; obtaining a plurality of tone-mapped pixel values by applying the plurality of tone mapping curves to the plurality of input pixel values according to the plurality of weight factors; and generating a tone-mapped output image based on the plurality of tone-mapped pixel values.

### 1. FIELD

The present disclosure relates to image processing, and more particularly to performing tone mapping while modifying a dynamic range of an image.

### 2. DESCRIPTION OF RELATED ART

Tone mapping is an important process used in digital imaging and display technologies to convert a wide range of luminance values in high dynamic range (HDR) images to a range that can be accurately displayed on standard dynamic range (SDR) displays. Some approaches for performing tone mapping struggle to preserve image details and color fidelity, leading to loss of visual information and suboptimal viewing experiences. As HDR content becomes increasingly prevalent in photography, cinematography, and gaming, there is a growing demand for more sophisticated tone mapping algorithms that can efficiently handle the complexity of HDR data while ensuring that the resultant images maintain high visual quality.

Neural networks (NNs) have been used to perform various tasks such as segmentation, object detection, and more. Accordingly, there is significant interest in applying NNs to tone mapping tasks. However, a major challenge in implementing these NNs is their size and computational load. Additionally, the ability to fine-tune the NNs based on feedback from users or customers poses another significant challenge.

### SUMMARY

Provided are systems, methods, and devices for performing tone mapping to modify a dynamic range of an input image, and for training at least one neural network model which may be used to perform the tone mapping.

Additional aspects will be set forth in part in the description which follows and, in part, will be apparent from the description, or may be learned by practice of the presented embodiments.

In accordance with an aspect of the disclosure, a method for performing tone mapping includes: obtaining an input image and at least one tuning parameter corresponding to the input image; obtaining a plurality of input pixel values corresponding to the input image; generating a plurality of tone mapping curves by providing the plurality of input pixel values and the at least one tuning parameter to a plurality of first neural network models; calculating a plurality of weight factors by providing the plurality of input pixel values and the at least one tuning parameter to a second neural network model; obtaining a plurality of tone-mapped pixel values by applying the plurality of tone mapping curves to the plurality of input pixel values according to the plurality of weight factors; and generating a tone-mapped output image based on the plurality of tone-mapped pixel values.

In accordance with an aspect of the disclosure, an electronic device for performing tone mapping includes: at least one processor; and a memory storing instructions which, when executed by the at least one processor, cause the electronic device to: obtain an input image and at least one tuning parameter corresponding to the input image, obtain a plurality of input pixel values corresponding to the input image, generate a plurality of tone mapping curves by providing the plurality of input pixel values and the at least one tuning parameter to a plurality of first neural network models, calculate a plurality of weight factors by providing the plurality of input pixel values and the at least one tuning parameter to a second neural network model, obtain a plurality of tone-mapped pixel values by applying the plurality of tone mapping curves to the plurality of input pixel values according to the plurality of weight factors, and generate a tone-mapped output image based on the plurality of tone-mapped pixel values.

In accordance with an aspect of the disclosure, a non-transitory computer-readable medium stores instructions which, when executed by at least one processor of an electronic device for performing tone mapping, cause the electronic device to: obtain an input image and at least one tuning parameter corresponding to the input image, obtain a plurality of input pixel values corresponding to the input image, generate a plurality of tone mapping curves by providing the plurality of input pixel values and the at least one tuning parameter to a plurality of first neural network models, calculate a plurality of weight factors by providing the plurality of input pixel values and the at least one tuning parameter to a second neural network model, obtain a plurality of tone-mapped pixel values by applying the plurality of tone mapping curves to the plurality of input pixel values according to the plurality of weight factors, and generate a tone-mapped output image based on the plurality of tone-mapped pixel values.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system for performing image processing, according to embodiments;

FIG. 2 is a block diagram of a tone mapping module, according to embodiments;

FIG. 3 is a block diagram of a tone mapping curve prediction model, according to embodiments;

FIG. 4 is a diagram showing an example of column-row convolution, according to embodiments;

FIG. 5 is a block diagram of a tone mapping curve prediction module including a plurality of tone mapping curve prediction models, according to embodiments;

FIG. 6 is a diagram showing an example of obtaining a plurality of tone-mapped luminance values, according to embodiments;

FIGS. 7A and 7B are diagrams showing an example of converting a grid of pixel values into indices and weights;

FIGS. 8A and 8B are block diagrams showing examples of tone mapping distribution modules, according to embodiments;

FIG. 9 is a diagram showing an example of tuning parameters for a tone mapping curve prediction model; according to embodiments;

FIG. 10 is a block diagram of an example of a training environment for training at least one neural network included in a tone mapping module, according to embodiments;

FIG. 11A is a flowchart of an example process for performing tone mapping, according to embodiments; and

FIG. 11B is a flowchart of an example process for training at least one neural network included in a tone mapping module, according to embodiments.

### DETAILED DESCRIPTION

As discussed above, tone mapping is an important process used in digital imaging and display technologies to convert a wide range of luminance values in some images (e.g., high dynamic range (HDR) images) to a range that can be accurately displayed on displays such as standard dynamic range (SDR) displays. Some approaches for performing tone mapping struggle to preserve image details and color fidelity, leading to loss of visual information and suboptimal viewing experiences. As HDR content becomes increasingly prevalent in photography, cinematography, and gaming, there is a growing demand for more sophisticated tone mapping algorithms that can efficiently handle the complexity of HDR data while ensuring that the resultant images maintain high visual quality.

In addition to display applications, tone mapping also plays an important role in automotive systems, including advanced driver-assistance systems (ADAS) and in-vehicle infotainment (IVI) systems. In ADAS, tone mapping may be used to process images from HDR cameras, enhancing the visibility of road conditions, obstacles, and signage under varying lighting conditions, thereby improving driver safety and the overall effectiveness of ADAS. In IVI systems, tone mapping may help to ensure that display screens present crucial details clearly to the driver and passengers, aiding in navigation and other visual tasks.

In automotive applications, due to the need to support varying illumination conditions—from direct sunlight to dark areas such as tunnels—the input dynamic range to the image signal processing (ISP) pipeline may be large, for example around 144 dB or 24 bits per pixel. However, the output may be drastically compressed, for example, to 8 bits per pixel for standard displays. This may pose a significant challenge for the effectiveness of the tone mapping algorithm.

Additionally, in both ADAS and IVI systems, the output from tone mapping may be used to perform computer vision (CV) tasks. Effective tone mapping is important for CV, especially considering that many neural network accelerators use fixed-point inputs and computations to save area. Accurate tone mapping may help to ensure that important visual information is preserved and optimized for machine learning algorithms, which may assist in performing tasks such as object recognition and scene understanding.

Machine learning models or artificial intelligence models such as neural network models may be used to perform various tasks such as segmentation, object detection, and more. Accordingly, there is significant interest in applying neural networks to tone mapping tasks. However, a major challenge in implementing these neural networks is their size and computational load. Additionally, the ability to fine-tune the neural network models based on feedback from users or customers poses another significant challenge

To address these challenges and others, embodiments of the present disclosure may relate to advanced tone mapping techniques that improve the preservation of detail in converted images, enhancing the overall viewing experience on display devices and optimizing its output for any computer vision application using compact trainable model while still allowing easy tuning.

For example, embodiments may use machine learning or artificial intelligence to convert input images (e.g., HDR images) to tone-mapped output images (e.g., low-dynamic range (LDR) images or SDR images) while enabling tuning of selectable parameters such as brightness and variance. Embodiments may also be used to dynamically optimize the output images for a computer-vision (CV) task or application.

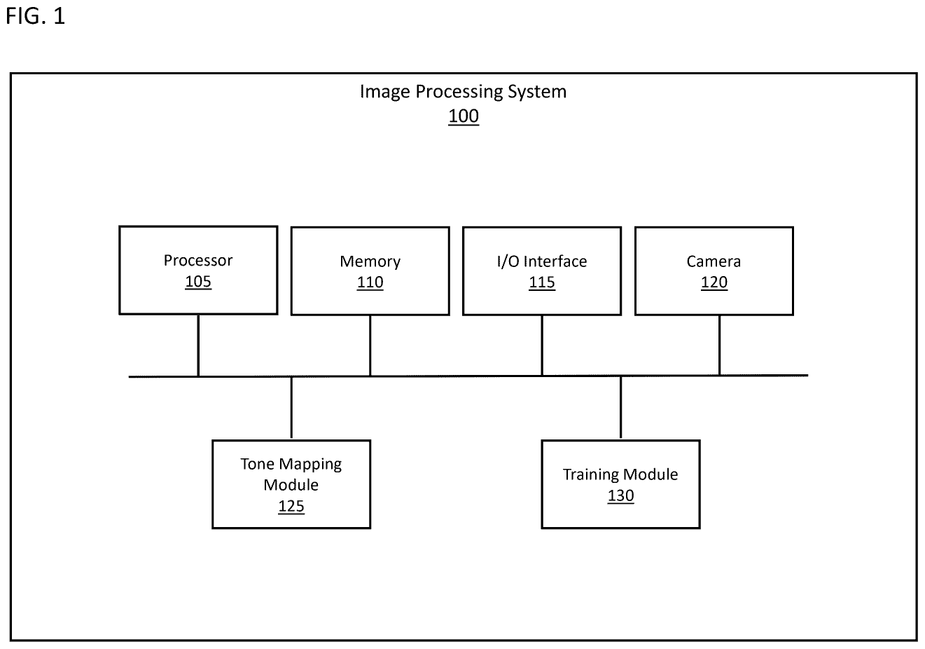

FIG. 1 is a block diagram of a system for performing image processing, according to embodiments. As shown in FIG. 1, the image processing system 100 may include a processor 105, a memory 110, an input/output (I/O) interface 115, a camera 120, a tone mapping module 125.

The processor 105 may be, or may include, an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 105 may configured to operate a memory array using a memory controller. For example, a memory controller may be integrated into the processor 105. In embodiments, the processor 105 may be configured to execute computer-readable instructions stored in a memory to perform various functions. However, embodiments are not limited thereto, and the memory controller may be included in any other element of the image processing system 100, for example in the memory 110.

The memory 110 (e.g., a memory device) may include at least one of a random access memory (RAM), a read-only memory (ROM), and a hard disk. For example, the memory 110 may include solid state memory and a hard disk drive. The memory 110 may be used to store computer-readable and computer-executable software including instructions which, when executed, may cause the processor 105 to perform various functions described herein. For example, the memory 110 may include, among other things, a basic input/output system (BIOS) which may control basic hardware or software operation such as the interaction with peripheral components or devices. In embodiments, the memory controller may operate memory cells. For example, the memory controller may include a row decoder, column decoder, or both. In some cases, memory cells within a memory 110 store information in as a logical state of the memory cells.

The I/O interface 115 may manage signals which are input from and output to the image processing system 100 and the elements included therein. The I/O interface 115 may also manage peripherals which not integrated into a device. For example, the I/O interface 115 may represent a physical connection or port to an external peripheral. In embodiments, the I/O interface 115 may utilize an operating system such as iOS®, ANDROID®, MS-DOS®, MS-WINDOWS®, OS/2®, UNIX®, LINUX®, or another operating system. In embodiments, the I/O interface 115 may represent or interact with a modem, a keyboard, a mouse, a display, a touchscreen, or a similar device. In embodiments, the I/O interface 115 may be implemented as part of a processor 105. In embodiments, a user may interact with a device using the I/O interface 115 or using hardware components controlled by the I/O interface 115.

The image processing system 100 may include an optical instrument (e.g., the camera 120, an image sensor, etc.) for recording or capturing images, which may be stored locally, transmitted to another location, etc. For example, the camera 120 may capture visual information using one or more photosensitive elements that may be tuned for sensitivity to a visible spectrum of electromagnetic radiation. A resolution of the visual information may be measured in pixels, where each pixel may relate an independent piece of captured information. In embodiments, each pixel may correspond to one component of, for example, a two-dimensional (2D) Fourier transform of an image. Computation methods may use pixel information to reconstruct images captured by the device. In the camera 120, one or more image sensors may convert light incident on a lens of the camera 120 into an analog or digital signal. The image processing system 100 may then display an image on a display panel based on the digital signal.

A pixel (e.g., a pixel sensor) may store information about received electromagnetic radiation (e.g., light). Each pixel may include one or more photodiodes and one or more complementary metal oxide semiconductor (CMOS) transistors. A photodiode may receive a light and may output charges. The amount of output charges may be proportional to the amount of light received by the photodiode. CMOS transistors may output a voltage based on charges output from the photodiode. A level of a voltage output from the photodiode may be proportional to the amount of charges output from the photodiode. For example, the level of the voltage output from a photodiode may be proportional to the amount of light received by the photodiode.

The tone mapping module 125 may be used to perform tone mapping on input images to obtain tone-mapped output images. For example, the tone mapping module 125 may receive an input image having a first dynamic range, for example a high-dynamic range (HDR) image, and may map a pixel value corresponding to each pixel in the input image to another pixel value corresponding to a different dynamic range to generate a tone-mapped output image having a second dynamic range, for example an LDR image or an SDR image. As one example, the input image may include pixel values within a range of one (“1”) and one million (“1,000,000”), and the pixel value for each pixel may be mapped to a pixel value within a range of one (“1”) to one thousand (“1,000”), but embodiments are not limited thereto. In embodiments, the input images may be images which are obtained or captured using the camera 120, or may be images which are received through the I/O interface 115, for example from another device. In embodiments, the output images may be displayed using a display or touchscreen included in the I/O interface 115, but embodiments are not limited thereto. For example, in some embodiments, the output images may be used by the processor 105 or another component of the image processing system 100 to perform CV tasks, or may be transmitted to another device using the I/O interface 115.

The training module 130 may be configured to train machine learning, artificial intelligence, and/or neural network models or architectures included in the image processing system 100, for example at least one neural network model included in the tone mapping module 125. In embodiments, the image processing system 100 may implement image processing networks to perform specialized tasks. For example, at least one of machine learning, artificial intelligence, and neural network processing may be implanted for various imaging and computer vision applications. A neural network may refer to a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network may refer to a hardware or a software component that includes a number of connected nodes (e.g., artificial neurons), which may loosely correspond to the neurons in a human brain. Each connection, or edge, may transmit a signal from one node to another (similar to the physical synapses in a brain). When a node receives a signal, the node may process the signal and then transmit the processed signal to other connected nodes. In embodiments, the signals between nodes may include real numbers, and the output of each node may be computed by a function of the sum of its inputs. In embodiments, the nodes may determine their outputs using other mathematical algorithms (e.g., selecting the max from the inputs as the output) or any other suitable algorithm for activating the node. Each node and edge may be associated with one or more node weights which may be used to determine how the signal is processed and transmitted.

During a training process, these weights may be adjusted, for example by the training module 130, to improve the accuracy of the result (e.g., by minimizing a loss function which corresponds in some way to the difference between the current result and the target result). The weight of an edge increases or decreases the strength of the signal transmitted between nodes. In embodiments, nodes may have a threshold below which a signal is not transmitted at all. In some embodiments, the nodes may be aggregated into layers, and different layers may perform different transformations on their inputs. The initial layer may be referred to as the input layer, and the last layer is known as the output layer. In some embodiments, signals may traverse certain layers multiple times. In embodiments, at least one of the weights and thresholds may be referred to as model parameters.

A convolutional neural network (CNN) may refer to a class of neural networks that may be used in computer vision or image classification systems. In embodiments, a CNN may enable processing of digital images with minimal pre-processing. A CNN may be characterized by the use of convolutional (or cross-correlational) hidden layers. These layers may apply a convolution operation to the input before signaling the result to the next layer. Each convolutional node may process data for a limited field of input, which may be referred to as the receptive field. During a forward pass of the CNN, filters at each layer may be convolved across the input volume, computing the dot product between the filter and the input. During the training process, the filters may be modified so that they activate when they detect a particular feature within the input. In embodiments, at least one machine learning model, artificial intelligence model, or neural network model included in the tone mapping module 125 may be, or may include, one or more image processing networks, for example one or more artificial neural networks, CNNs, etc., which may be trained using the training module 130.

In embodiments, the training module 130 may be used to train at least one machine-learning, artificial intelligence, or neural network model included in the image processing system 100, for example included in the tone mapping module 125. According to embodiments, at least one the tone mapping module 125 may be trained using two parallel training processes, for example a first training process for weight map prediction, and a second training process for tone mapping curve prediction. According to embodiments, these training processes may be performed using the training module 130.

Accordingly, embodiments of the present disclosure may use artificial intelligence to convert HDR input images to LDR output images or SDR output images while enabling tuning of selectable parameters such as brightness and variance. Embodiments may also be used to dynamically optimize the output images for a CV task or application.

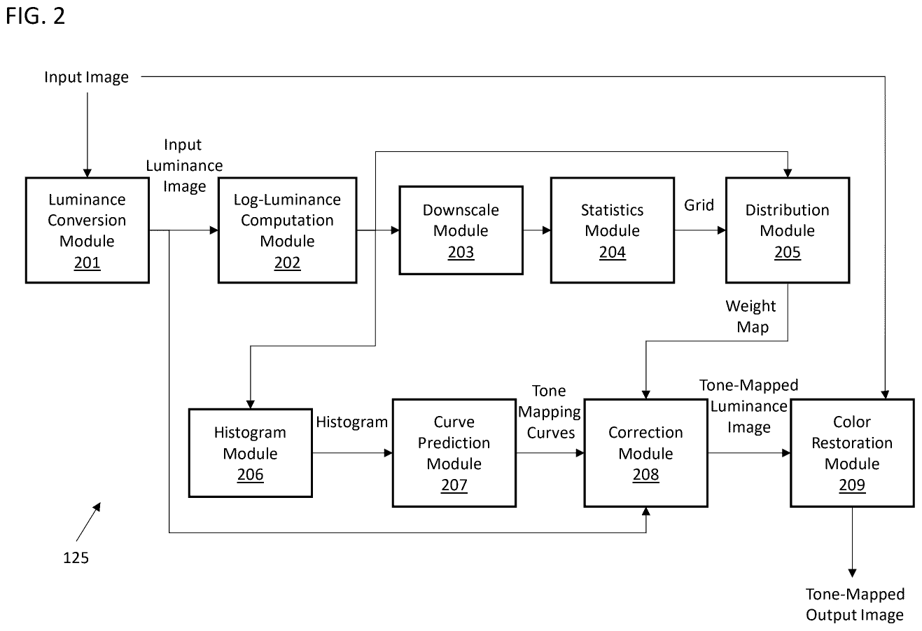

FIG. 2 is a block diagram of a tone mapping module, according to embodiments. As shown in FIG. 2, the tone mapping module 125 may include a luminance conversion module 201, a log-luminance computation module 202, a downscale module 203, a statistics module 204, a distribution module 205, a histogram module 206, a curve prediction module 207, a correction module 208, and a color restoration module 209.

As discussed above, the tone mapping module 125 may receive an input image having a first dynamic range, for example a high-dynamic range (HDR) image, and may map a pixel value corresponding to each pixel in the input image to another pixel value corresponding to a different dynamic range to generate a tone-mapped output image having a second dynamic range, for example an LDR image or an SDR image. Some approaches to tone mapping may use a single tone mapping curve or look-up table (LUT) to perform the mapping, which may often be generated and stored in advance. Other approaches may use classical heuristic methods to dynamically generate a plurality of tone-mapping curves.

In contrast, the tone mapping module 125 according to embodiments may use machine learning or artificial intelligence to generate a plurality of tone mapping curves for each input image, and may further generate one or more weights or weight factors for each pixel which may be used to combine the tone mapping curves on a pixel-by-pixel basis to generate the output image. For example, the plurality of tone mapping curves may be used to generate a plurality of reduced dynamic range images (e.g., LDR images or SDR images) corresponding to the input image, and the weight factors may be used to combine pixels of the plurality of LDR images to generate the output image.

In embodiments, the tone mapping module 125 may be capable of learning a rich variety of local tone mapping adjustments. For example, the tone-mapping module may be trained to estimate pixel-wise weight maps and tone mapping curves for a given input image (e.g., an HDR image) and to output a tone-mapped image (e.g., a tone-mapped LDR image or a tone-mapped SDR image).

The luminance conversion module 201 may convert the input image into a luminance image, which may be referred to as an input luminance image. For example, in some embodiments, the tone mapping may be performed based on luminance values, which may also be referred to as luminosity values. Accordingly, the luminance conversion module 201 may obtain a luminance value corresponding to each pixel included in the input image, and may generate the input luminance image based on the obtained luminance values, which may be referred to as input luminance values.

The log-luminance computation module 202 may generate a log-transformed luminance image corresponding to the input luminance image, which may be referred to as a log-luminance image. For example, the log-luminance computation module 202 may calculate a logarithm of each luminance value included in the input luminance image to obtain a log-luminance value for each pixel, and the log-luminance image may include these log-luminance values. In embodiments, the log-luminance computation module may perform these calculations using a piece-wise-linear LUT, but embodiments are not limited thereto.

The downscale module 203 may perform downscaling on the log-luminance image to obtain a downscaled log-luminance image, which may have a relatively low resolution (e.g., a resolution that is lower than a resolution of the input image).

The statistics module 204 may collect local statistics. The statistics module 204 may receive the downscaled log-luminance image as an input, and may extract features (e.g., coefficients). The output may be a low-resolution feature map, which may be referred to as a grid, and which may be provided to the distribution module to create the weight map. Examples of the structure and operation of the statistics module 204 are described in greater detail below.

According to embodiments, the statistics module 204 may be responsible for converting the logarithm of the luminance values of the input image into a three-dimensional (3D) feature map. In some embodiments, the statistics module 204 may use a neural network model such as a deep learning model to transform the downscaled log-luminance image into a 3D grid. For example, an input image having a resolution of 320×240 (e.g., a quarter video graphics array (QVGA) input image) may be converted into a 20×15×8 grid using a neural network model included in the statistics module 204. This conversion may be achieved using downscaling operations such as convolution and strides (e.g., a simple convolutional network), or any other process. The choice of input resolution and grid size may be influenced by factors such as hardware computational capacity and real-time requirements on one hand, and the supported full resolution on the other. For example, according to embodiments, an input image having a 320×240 and a grid size of 20×15×8 may be used to support 24-bit HDR images with a resolution of 4080×3060, but embodiments are not limited thereto

The distribution module 205 may extend the coefficients provided by the statistics module 204 for the full-resolution image using data-dependent lookups (e.g., a 2D grid of coefficients). The distribution module 205 may generate a weight factor corresponding to each pixel included in the full-resolution input image based on the learned features and the luminance value of the pixel. In embodiments, if more than two tone-mapping curves are used, the distribution module 205 may generate more than one weight factor for each pixel. According to embodiments, the weight map generated by the distribution module 205 may be used to detect uniform light areas while preserving edges in order to enable different enhancements for areas under different light conditions. Examples of the structure and operation of the distribution module 205 are described in greater detail below.

In embodiments, each of the statistics module 204 and distribution module 205 may be implemented using a neural network-based approach (e.g., an approach using a deep learning model) or using a classical approach (e.g., a non-neural network based approach such as an approach based on a machine-learning algorithm or another type of algorithm). For example, a classical implementation of the distribution module 205 may apply trilinear interpolation to compute the one or more weight factors for each pixel. In embodiments, if one or more of the statistics module 204 and the distribution module 205 are implemented using a neural network-based approach, they may be trained together with the other components included in the tone mapping module 125 in an end-to-end manner.

The histogram module 206 may receive the log-luminance image from the log-luminance computation module 202, and may generate a corresponding histogram, which may be provided as input to the curve prediction module 207.

The curve prediction module 207 may receive the luminance log-transformed histogram of the input image (e.g., the output of the histogram module 206) as an input, and may output a plurality of tone mapping curves. For example, the curve prediction module 207 may include a plurality of curve prediction models which may be used to generate the plurality of tone mapping curves. In some embodiments, the plurality of tone mapping curves may be represented by, or implemented using, a plurality of LUTs which may be generated by the curve prediction module 207 for each input image, and may be stored in the tone mapping module 125 or in another component of the image processing system 100. Examples of the structure and operation of the curve prediction module 207 are described in greater detail below.

The correction module 208 may receive the plurality of tone mapping curves (e.g., the plurality of tone mapping LUTs) generated by the curve prediction module 207 and the weight map generated by the distribution module 205, and may generate a tone-mapped luminance image corresponding to the input luminance images. For example, the correction module 208 may apply the plurality of tone mapping curves generated by the curve prediction module 207 to the input luminance image, and the result for each pixel may be combined using a weighted sum that may be obtained based on the weight factors included in the weight map generated by the distribution module 205 to generate tone-mapped luminance values included in the tone-mapped luminance image.

For example, in some embodiments, each of the plurality of tone mapping curves may be used to generate a full-resolution image having a reduced dynamic range (e.g., a full-resolution LDR image or SDR image) corresponding to the input luminance image. In embodiments, each of these full-resolution reduced dynamic range images may correspond to a different dynamic range that is smaller than a dynamic range of the input image. Then, the correction module 208 may combine the plurality of reduced dynamic range images on a pixel-by-pixel basis using the one or more weight factors corresponding to each pixel to generate the tone-mapped luminance image.

According to embodiments, the tone mapping discussed above may operate on the luminance values (e.g., the brightness levels) of the input image and should therefore not affect the color ratio. Therefore, the color restoration module may be used to obtain the tone-mapped output image by restoring color values of the tone-mapped luminance image based on the color values of the input image. For example, the color restoration module 209 may apply an inverse red-green-blue (RGB)-gamma function the tone-mapped luminance image, and may restore the color ratio of the input image using Equation 1 below:

$${R}_{ldr} = {R}_{hdr} \cdot \frac{{L}_{ldr}}{{L}_{hrr}} \qquad Equation 1$$

In Equation 1 above, R_{ldr} may denote the constructed red channel of the tone-mapped output image, R_{hdr} may denote the red channel of the input image, L_{hdr} may denote the luminance channel of the input image (e.g., the luminance values included in the input image), and L_{ldr} may denote the tone-mapped luminance values included in the tone-mapped luminance image.

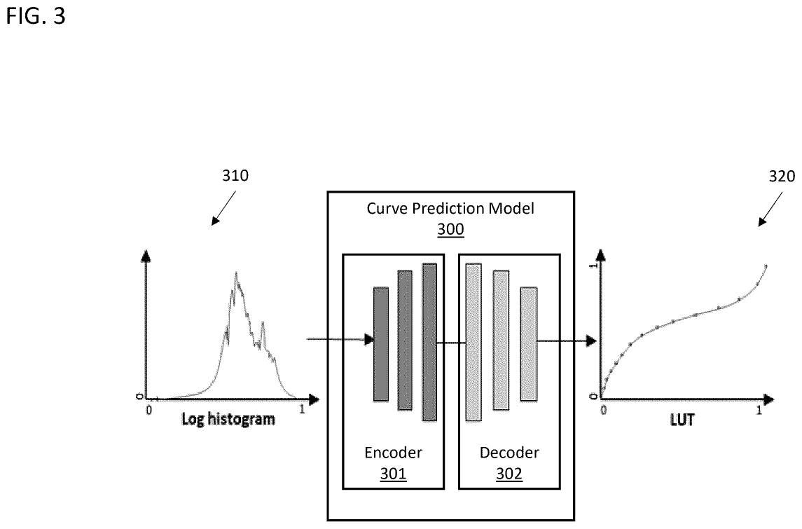

FIG. 3 is a block diagram of a tone mapping curve prediction model, according to embodiments.

In some embodiments, the color restoration module 209 may include or may implement a color restoration function, which may be for example an inverse gamma function. For example, this function may be used to undo or reverse the effects of a gamma function that may be applied by an image signal processor (ISP), which may for example follow Equation 2 below, or may be customized by vendors for optimal color representation.

$$f ( x ) = {x}^{0.45}$$

In Equation 2 above, x may denote an input luminance value, and ƒ(x) may denote an output of the ISP gamma function. Because embodiments may work in linear space and may target images processed through the pipeline, an inverse gamma operation may be used to maintain a direct mapping between HDR luminance and tone-mapped luminance.

For example, some embodiments may apply an inverse gamma function to the target luminance during training, which may require knowledge of the specific gamma function used by the ISP. As another example, some embodiments may apply an inverse gamma function within the color restoration module 209 when performing inference. In order to accomplish this, the L_{ldr} may denote the tone-mapped luminance values after the inverse gamma function is applied. This may allow the gamma configuration to be decoupled from the training process, and may allow a preferred gamma configuration to be used without affecting the trained models.

In embodiments, at least one of the curve prediction model 300 may be included in the curve prediction module 207. The curve prediction model may be a machine-learning or artificial intelligence model, for example a neural network model such as a deep learning model, but embodiments are not limited thereto. As shown in FIG. 3, the curve prediction model 300 may receive the log-luminance histogram 310, which may be for example received from the histogram module 206, and may output a tone mapping curve which may be expressed or represented as a tone mapping LUT 320. According to embodiments, the curve prediction model 300 may be constructed and trained to generate tone mapping curves which meet certain criteria. For example, in some embodiments the pixel value range of the images produced using the tone mapping curve may be within a normalized range of [0, 1], the tone mapping curve may be monotonically increasing to preserve the contrast between neighboring pixels and to prevent visible inversions artifacts, and the tone mapping curve may be smooth to ensure a visually pleasing result.

In some embodiments, the curve prediction model 300 may be designed as a lightweight deep neural network. The curve prediction model 300 may generate the tone mapping LUT 320 including a set of points {(x, y)}ᵢ, i∈[0, N]. The input to the curve prediction model 300 may be a log-luminance histogram 310 with N bins extracted from the input image as discussed above. The output of the curve prediction model 300 may be a vector of N samples

$${\{ Δ y \}}_{i = 0}^{N} ,$$

where each Δy represents the change in the y value in comparison to the previous sample. The

$${\{ y \}}_{i = 0}^{N} ,$$

points may be derived from the accumulation and normalization of the

$${\{ Δ y \}}_{i = 0}^{N} ,$$

samples. The

$${\{ x \}}_{i = 0}^{N}$$

points may be a set of fixed points sampled in the range [0,1] in the log-space. These points, combined with the

$${\{ y \}}_{i = 0}^{N}$$

points, may form the tone mapping LUT 320, and may represent the estimated monotonous and normalized curve function.

As shown in FIG. 3, the curve prediction model 300 may include an encoder model 301 and a decoder model 302 arranged in an encoder-decoder structure. The encoder model 301 may include of two column-row convolution layers, each of which may be followed by a rectified linear unit (ReLU) activation function. The decoder model 302 may include two two-dimensional convolution (conv2d) layers. The final fully connected layer may be followed by a sigmoid activation function.

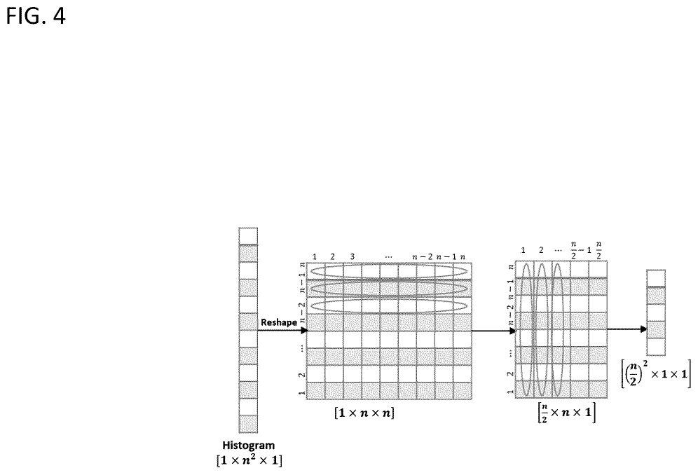

FIG. 4 is a diagram showing an example of column-row convolution, according to embodiments. The architecture of a column-row convolution layer may be designed to reduce the size of the encoder model 301, making it more practical for implementation. This may be achieved by modifying the fully connected layer, where each neuron applies a linear transformation to the input vector using a weight matrix. In a fully connected layer, all possible connections between the input and output layers are present, meaning every input element may influence every output element. In contrast, the column-row convolution layer corresponding to FIG. 4 may reshape the input vector into a matrix and establish connections only between the rows and columns separately. This layer may accept an input vector of size [1×n²×1] and produce an output vector of size

$$[ {( \frac{n}{2} )}^{2} \times 1 \times 1 ] .$$

The process may begin with reshaping the input vector into a matrix of size[1×n×n] where n may denote the row/column size. Then, a group-wise Conv2D layer with a kernel size of [1×n],

$$\frac{n}{2}$$

channels and n groups may be applied to create connections between the n columns of the matrix. This may result in a matrix of size

$$[ \frac{n}{2} \times n \times 1 ] .$$

Next, another group-wise Conv2D layer with a kernel size of [n×1],

$$\frac{n}{2}$$

channels and

$$\frac{n}{2}$$

groups may be applied. This layer may create a reduced vector of size

$$\frac{n}{2}$$

for each of the

$$\frac{n}{2}$$

reduced rows, resulting in a final output matrix of size

$$[ {( \frac{n}{2} )}^{2} \times 1 \times 1 ] .$$

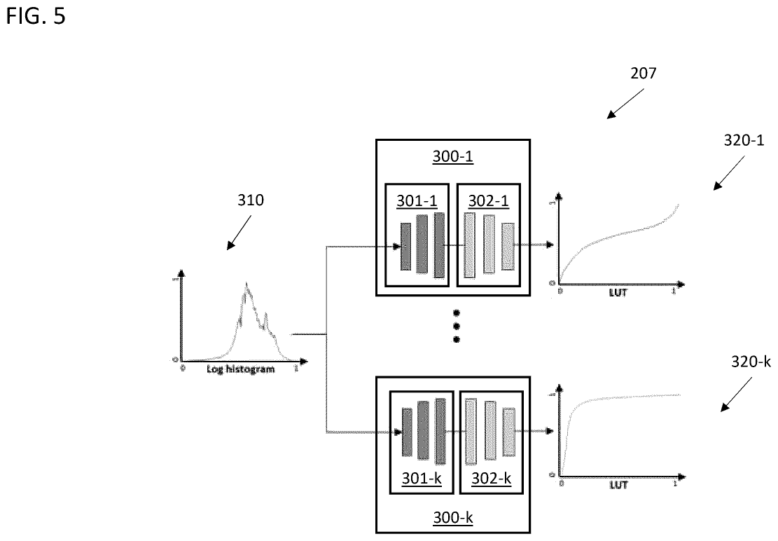

This model may be extended to generate custom number of tone mapping curves for a specific input image by utilizing multiple parallel models, an example of which is shown in FIG. 5.

FIG. 5 is a block diagram of a tone mapping curve prediction module including a plurality of tone mapping curve prediction models, according to embodiments. As shown in FIG. 5, the curve prediction module 207 may include a plurality of curve prediction models 300, for example a first curve prediction model 300-1 including an encoder model 301-1 and a decoder model 302-1, through a k^{th} curve prediction model 300-k including an encoder model 301-k and a decoder model 302-k. Each of the plurality of curve prediction models 300 may receive the same log-luminance histogram 310 as input, and may produce a different tone mapping curve to be used by the tone mapping module 125.

For example, as shown in FIG. 5, the first curve prediction model 300-1 may generate a first tone mapping curve corresponding to a first tone mapping LUT 320-1, and the k^{th} curve prediction model 300-k may generate a k^{th} tone mapping curve corresponding to a k^{th} tone mapping LUT 320-k. In some embodiments, each of the curve prediction models 300 may produce a tone mapping LUT 320 which corresponds to a different dynamic range. For example, in some embodiments, one tone mapping LUT 320 may correspond to relatively bright areas of the input image, and another tone mapping LUT 320 may correspond to relatively dark areas of the input image. However, this is only an example, and embodiments are not limited thereto.

For convenience of description, examples are described herein in which the curve prediction module 207 includes two curve prediction models 300 and produces two tone mapping LUTs 320 (e.g., a curve prediction module 207 in which k=2), but embodiments are not limited thereto, and the curve prediction module 207 may include any number of curve prediction models 300.

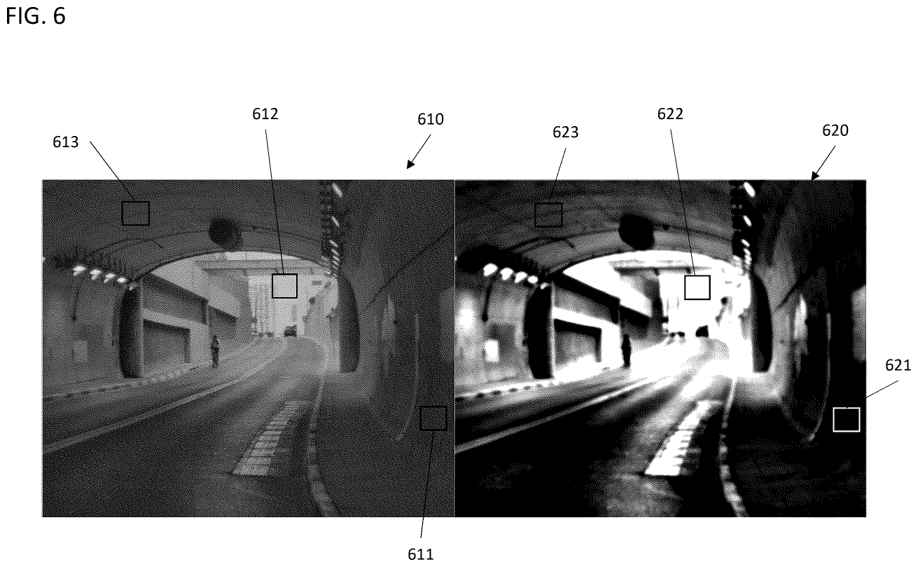

FIG. 6 is a diagram showing an example of obtaining a plurality of tone-mapped luminance values, according to embodiments. As discussed above, the statistics module 204 and the distribution module 205 may be used to estimate a weight map within a range [0,1], which may be used to identify uniform light areas while preserving edges. This weight map may enable different enhancement applications for areas under different light conditions. The luminance value of each pixel in the input image may be transformed based on the corresponding weight factor and the corresponding values of the two curve functions, and the resulting tone-mapped luminance image may therefore be obtained. FIG. 6 shows an example of this local operation, which includes two curves.

As shown in FIG. 6, the luminance values included in an input image 610 may be transformed according to weight factors included in a corresponding weight map 620. Pixels corresponding to a weight factor of zero (“0”) (e.g., pixels in the region 611 and the region 621) may be transformed using a first tone mapping LUT, pixels corresponding to a weight factor of one (“1”) (e.g., pixels in the region 612 and the region 622) may be transformed using a second tone mapping LUT, and pixels corresponding to a weight in the range (0,1) (e.g., pixels in the region 613 and the region 623) may be transformed through linear interpolation between these first tone mapping LUT and the second tone mapping LUT according to Equation 2 below.

$${y}_{out} = ω \cdot {y}_{lut 1} + ( 1 - ω ) \cdot {y}_{lut 2} . \qquad Equation 2$$

In Equation 2 above, yₒᵤₜ may denote the tone-mapped luminance value of a pixel, yₗᵤₜ₁ may denote a value of the first tone mapping LUT corresponding to the pixel, yₗᵤₜ₂. may denote a value of the second tone mapping LUT corresponding to the pixel, and ω may denote a weight factor corresponding to the pixel.

The final tone-mapped output image may be recovered using a color restoration procedure, which may include multiplying the input image by the ratio between the luminance of the tone-mapped luminance image and the luminance the input image, as discussed above.

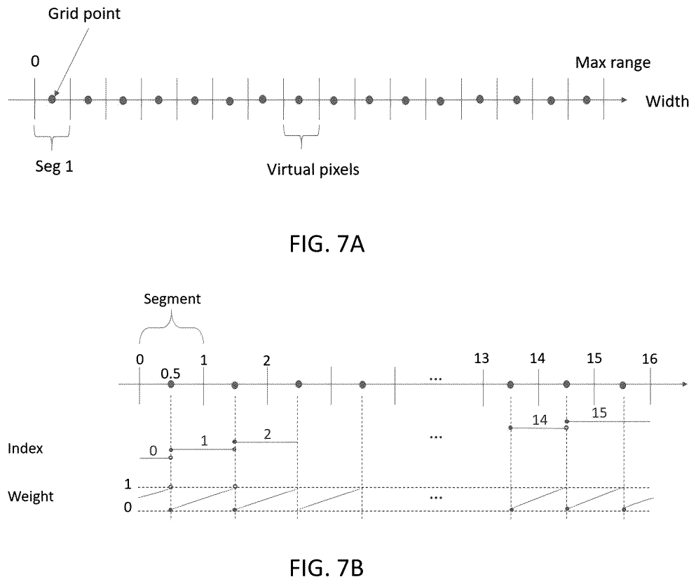

FIGS. 7A and 7B are diagrams showing an example of converting a grid of pixel values into indices and weights. As discussed above, the distribution module 205 may generate a weight map including per-pixel weight factors corresponding each pixel included in the full-resolution input image. According to embodiments, the weight factors may be computed using bi-lateral interpolation or a neural network model. In some embodiments, a relatively slim or lightweight neural network model may be used to operate on the full resolution image. Using larger models may result in an extensive computational load and difficulty complying with real-time requirements. Using a neural network model in the distribution module 205 may allow user tuning and may provide the possibility to add temporal stability regularizations. As the distribution module 205 operates on local patches of the input image, it may be possible to introduce tuning parameters. These tuning parameters, which may also be referred to as tuning handles, may enable local adjustment. For example, in some embodiments, a tuning parameter may be used to control local contrast in textured regions, etc. Both the neural network-based implementation and the bi-lateral-based implementation of the distribution module 205 may use the log-luminance image and the 3D features grid, expanding them to match the full resolution input image.

According to embodiments, the spatial indices (x, y) and the log luma index z indices of each pixel may be converted into grid indices and weights, that may be corresponded to the relative position inside the grid. The pixels of the input image, as shown for example in FIG. 7A, may be converted into virtual pixels, as shown for example in FIG. 7B, by stretching each segment based on the desired bit range. The example illustrated in FIGS. 7A and 7B shows how a grid of 16 pixel values may be converted into indices and weights. In addition, the final per-pixel weight may then be transformed into a fixed range [0, 1], which may be done using a shifted Sigmoid

$$\frac{1}{1 + {e}^{- x}} - 0.5 ,$$

for example.

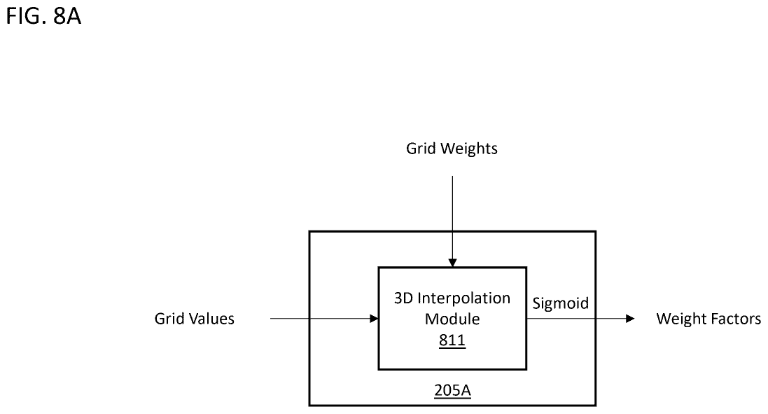

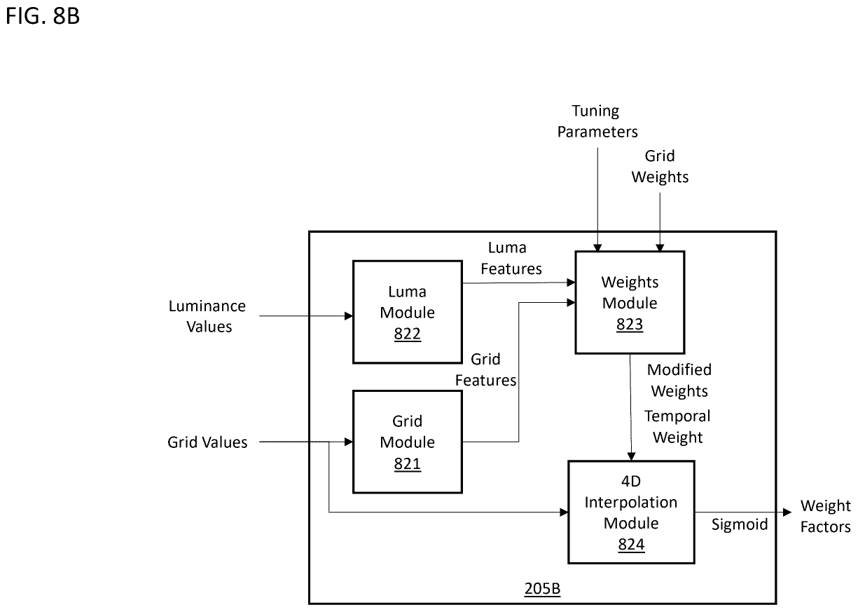

FIGS. 8A and 8B are block diagrams showing examples of tone mapping distribution modules, according to embodiments. In particular, FIG. 8A illustrates an example in which a distribution module 205A is implemented using a classical approach, and FIG. 8B illustrates an example in which a distribution module 205B is implemented using a neural network-based approach. According to embodiments, the distribution module 205A and the distribution module 205B may be examples of the distribution module 205 discussed above.

As shown in FIG. 8A, the distribution module 205A may include a 3D interpolation module 811. In embodiments, the 3D interpolation module 811 may perform an interpolation between grid values G and grid weights w using a trilinear interpolation to obtain weight factors W according to Equation 3, Equation 4, and Equation 5 below:

$${G}_{y} [ x , z ] = G [ x , 0 , z ] \cdot {w}_{y} + ( 1 - {w}_{y} ) \cdot G [ x , 1 , z ] \qquad Equation 3$$

$${G}_{y , x} [ z ] = {G}_{y} [ 0 , z ] \cdot {w}_{x} + ( 1 - {w}_{x} ) \cdot {G}_{y} [ 1 , z ] \qquad Equation 4$$

$$W = {G}_{y , x} [ 0 ] \cdot {w}_{z} + ( 1 - {w}_{z} ) \cdot {G}_{y x} [ 1 ] \qquad Equation 5$$

As shown in FIG. 8B, the distribution module 205B may include a grid module 821, a luma module 822, a weights module 823, and a four-dimensional (4D) interpolation module 824. According to embodiments, the distribution module 205B may be implemented using a relatively slim or lightweight neural network model, only several hundreds of parameters and multiply-accumulate (MAC) operations for each pixel.

As shown in FIG. 8B, for each pixel, the distribution module 205B may receive as input log-luminance values of neighboring pixels. In embodiments, the neighboring pixels may be a matrix of N×N around the pixel (e.g. a 5×5 matrix), and may be referred to as a luma patch. In some embodiments, this may be reduced to a lower bit width (e.g., 24-bit to 16-bit. In addition, the distribution module 205B may receive a 3D feature map (e.g., a 3D grid) generated by the statistics module 204, which may include the grid values and grid weights discussed above. In some embodiments, the distribution module 205B may receive a 3D feature map for the current input image as well as one or more previous images. In addition, the distribution module 205B may receive one or more tuning parameters, which may be used to tune characteristics of the tone-mapped output image (e.g. contrast, brightness etc.). In embodiments, the tuning parameters may be constant over the entire input image.

The grid module 821 may use a plurality of pixel-wise fully-connected layers to process the grid values into features. The luma module 822 may use horizontal and vertical filters to process the luma patches around the pixels into luma features. The weights module 823 may use a plurality of fully-connected layers to process its inputs into three spatial weight modifiers (e.g., a weight modifier corresponding to x, a weight modifier corresponding to y, and a weight modifier corresponding to z) and a temporal weight. The weight modifiers may be used to change the input grid weights based on a piece-wise linear function. The 4D interpolation module 824 may receive the three spatial weights, one temporal weight and grid values, and may perform a 4D classical interpolation.

According to embodiments, the distribution module 205B may provide a better solution in comparison to a simple bi-lateral interpolation, based on the relevant data for the task. In addition, distribution module 205B may allow the output to be tuned, for example by changing the tuning parameters, in order to change aspects of the tone mapping to achieve a desired result. The distribution module 205B may also be more stable in terms of temporal change (e.g., changes between input images), because it may receive information from several images, and not just the current input image as in a classical bi-lateral approach. In the example shown in FIG. 8B, the distribution module 205B is described as receiving the grid of a previous input image, but embodiments are not limited thereto. For example, in some embodiments, other information from previous input images may be provided to the distribution module 205B, for example LUTs, histograms and even image data.

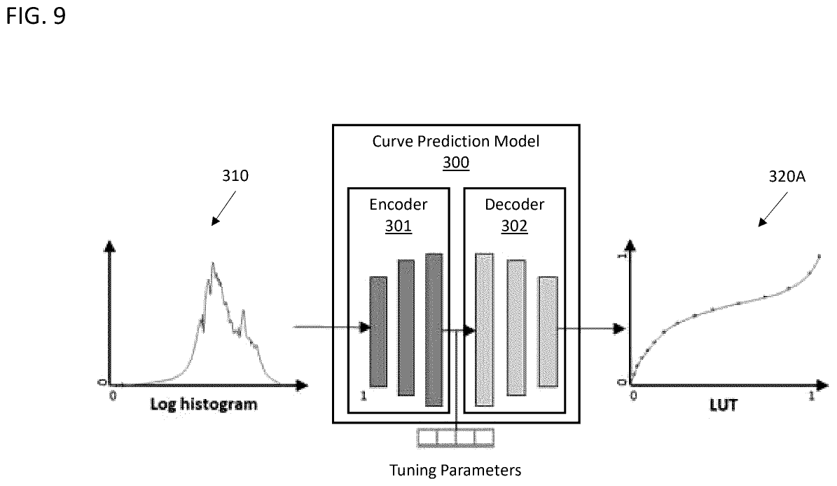

FIG. 9 is a diagram showing an example of tuning parameters for a tone mapping curve prediction model, according to embodiments. The quality of the resulting tone-mapped output image (and image quality in general) may be subjective, and may vary depending on the preferences of the user. To provide users with more control over the final tone-mapped image, embodiments may include a one or more tuning parameters that may allow users to adjust the output image to their liking.

Adjusting images may generally not be a simple task. For example, even contrast and brightness adjustments may be challenging because they may require consideration of image content and difficult lighting situations. Integrating controls for these parameters into the tone mapping module 125 may greatly benefit from the ability to adjust the LUTs and potentially achieve a smoother and improved result. Accordingly, some embodiments may provide an end-to-end training process that may include predefined feature controls and may predict the optimal LUT values for the tuning task.

FIG. 9 illustrates a curve prediction model 300A, which may be an example of the curve prediction model 300 above. In embodiments the curve prediction model 300A may receive one or more tuning parameters as input along with the log-luminance histogram 310, and may generate a tone mapping curve which may be represented using tone mapping LUT 320A.

The quality of the resulting tone-mapped output image (and image quality in general) may be subjective, and may vary depending on the preferences of the user. To provide users with more control over the final tone-mapped image, embodiments may include a one or more tuning parameters that may allow users to adjust the output image to their liking.

In general, adjusting images may not be a simple task. For example, even contrast and brightness adjustments may be challenging because they may require consideration of image content and difficult lighting situations. Integrating controls for these parameters into the tone mapping module 125 may greatly benefit from the ability to adjust the LUTs and potentially achieve a smoother and improved result.

Accordingly, some embodiments may provide an end-to-end training process that may include predefined feature controls and may predict the optimal LUT values for the tuning task. In some embodiments, the training process described below may be implemented or performed using the training module 130, but embodiments are not limited thereto.

In the example described below, the curve prediction model 300A may learn and output two curves based on two tuning parameters: a first tuning parameter that may be used increase or decrease the mean luminance of the tone-mapped output image, and a second tuning parameter that may be used to control the overall contrast of the tone-mapped output image. According to embodiments, the curve prediction model 300 may be useful for these tuning parameters because it directly affects these image characteristics. As shown in FIG. 9, the two tuning parameters may be concatenated the features output by the encoder model 301, and the resulting concatenated vector may be used as an input for the decoder model 302.

End-to-end training with tuning parameters may present a challenge due to the limited availability of training data that covers different tuning settings. One potential option to address this issue is to obtain pairs of input images, tuning handles, and their corresponding ground truth references. Another option is to adopt a self-supervised approach.

According to the self-supervised approach, a structural similarity index (SSIM) loss may be used to incorporate the tuning parameters, which may allow for multiplicative adjustments of contrast or brightness levels (which may be referred to as gains). This adaptation may allow a new dataset to be generated that links the gains with their corresponding adjusted references.

According to embodiments, the SSIM may be computed on various windows of an image. The measure between two windows, p (from the tone-mapped output image) and q (from the input image), of common size N×N may include three components: luminance (l(p,q)), contrast (c(p,q)), and structure (s(p,q)). These components may be calculated according to Equation 6, Equation 7, and Equation 8 below, and the SSIM may be calculated using Equation 9:

$$l ( p , q ) = \frac{2 {μ}_{p} {μ}_{q} + {c}_{1}}{{μ}_{p}^{2} + {μ}_{q}^{2} + {c}_{1}} \qquad Equation 6$$

$$c ( p , q ) = \frac{2 {σ}_{p} {σ}_{q} + {c}_{2}}{{σ}_{p}^{2} + {σ}_{q}^{2} + {c}_{2}} \qquad Equation 7$$

$$s ( p , q ) = \frac{2 {σ}_{pq} + {c}_{2}}{{σ}_{p}^{2} + {σ}_{q}^{2} + {c}_{2}} \qquad Equation 8$$

$$SSIM ( p , q ) = {l ( p , q )}^{α} \cdot {c ( p , q )}^{β} \cdot {s ( p , q )}^{γ} \qquad Equation 9$$

In the Equations above, c₁=(k₁L)², c₂=(k₂L)² may denote stabilization factors, and L may denote a constant corresponding to the dynamic range of the pixel values k₁=0.01, k₂=0.03 by default.

To emulate different average luminance and contrast, the respective components may be obtained by multiplying them with a factor gₗ for luminance and a factor g_{c} for contrast, as shown in Equation 10 and Equation 11 below:

$$l ( p , q ) = \frac{2 {μ}_{p} \cdot {g}_{l} {μ}_{q} + {c}_{1}}{{μ}_{p}^{2} + \cdot {g}_{l}^{2} {μ}_{q}^{2} + {c}_{1}} \qquad Equation 10$$

$$c ( p , q ) = \frac{2 {σ}_{p} \cdot {g}_{c} {σ}_{q} + {c}_{2}}{{σ}_{p}^{2} + {g}_{c}^{2} {σ}_{q}^{2} + {c}_{2}} \qquad Equation 11$$

According to embodiments, training the luminance tuning parameter and the contrast tuning parameter may present challenges because these image characteristics may be interdependent. For example, luminance changes may lead to contrast changes, not vice versa. This can be explained by considering a brightness increase of a signal. When a brightness of a signal is increased by a factor, both the brightness and the gradients are increased by the same factor. As a result, when the tone mapping module 125 learns to increase the mean luminance of an image, the contrast may also increase, which may negatively affect the contrast component score since it may be calculated relative to the original contrast. To mitigate this, the contrast component may be divided by the mean luma gain, as shown in Equation 12 and Equation 13 below:

$$l ( p , q ) = \frac{2 {μ}_{p} \cdot {g}_{l} {μ}_{q} + {c}_{1}}{{μ}_{p}^{2} + \cdot {g}_{l}^{2} {μ}_{q}^{2} + {c}_{1}} \qquad Equation 12$$

$$c ( p , q ) = \frac{2 \cdot \frac{{σ}_{p}}{{g}_{l}} \cdot {g}_{c} {σ}_{q} + {c}_{2}}{\frac{{σ}_{p}^{2}}{{g}_{l}^{2}} + {g}_{c}^{2} {σ}_{q}^{2} + {c}_{2}} \qquad Equation 13$$

To incorporate additional tuning parameters, the training dataset may be divided into different modes. For example, in the context of tone mapping, these modes could be defined as indoor images, outdoor images, etc. As another example, in a more general case, the training images may be clustered based on the feature maps of a middle layer from the curve prediction model 300, identifying cases in which the curve prediction model 300 found similarities.

By segmenting the training dataset into different modes, the curve prediction model 300 (and by extension the tone mapping module 125) may be trained to incorporate the mode index as an input. This may allow for additional flexibility in controlling or tuning the tone mapping behavior. This approach may reduce the complexity of the curve prediction model 300 by offloading the logic of mode detection to an external process.

Furthermore, the curve prediction model 300 into two parts: one connected to the tuning parameters and the other responsible for processing input images in real-time. The real-time part of the curve prediction model 300 may use stronger hardware to handle the high frame rate, while, the part of the curve prediction model 300 connected to the tuning parameters may produce the coefficients for the real-time model, but these changes may occur at a slower pace. This strategy may allow the load to be distributed between the two parts, resulting in higher performance at a lower cost.

Another requirement for the tone mapping curves may be smoothness, which may aim to avoid contours in the tone-mapped output image. To enforce this smoothness, the loss function may be designed to produce a high error if the slope between two consecutive points (xᵢ,yᵢ), and (xᵢ₊₁,yᵢ₊₁) is larger than the “natural slope” of the line that is going through the (xᵢ₊₁,yᵢ₊₁) point and the axis origins. This error E may be calculated according to Equation 14 below:

$$E = {[ {\sum }_{i} {( ReLU ( \frac{\frac{{y}_{i + 1} - {y}_{i}}{{x}_{i + 1} - {x}_{i}}}{\frac{{y}_{i + 1}}{{x}_{i + 1}}} - 1 ) )}^{3} ]}^{\frac{1}{3}} \qquad Equation 14$$

In this example, the natural slope may be defined as

$$\frac{{y}_{i + 1}}{{x}_{i + 1}} .$$

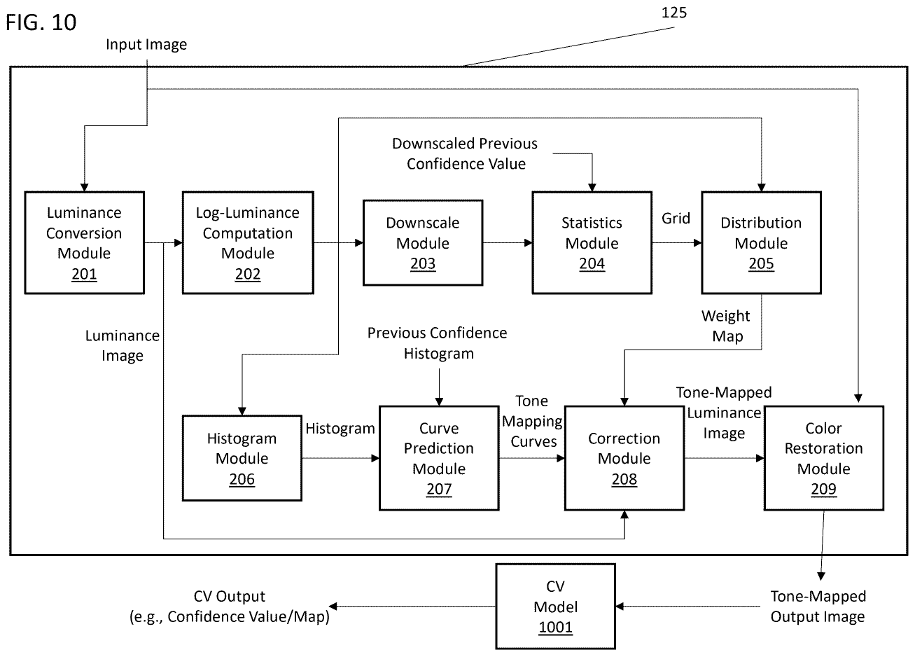

FIG. 10 is a block diagram of an example of a training environment for training at least one neural network included in a tone mapping module, according to embodiments. In some embodiments, the training environment illustrated in FIG. 10 and described below may be implemented or performed using the training module 130, but embodiments are not limited thereto.

In some embodiments, the tone mapping module 125 may be used to enhance the performance of a CV engine, for example the CV model 1001 shown in FIG. 10. According to embodiments, the tone mapping module 125 may receive inputs from the CV model 1001 and adapt its behavior and configuration to improve performance in consecutive frames.

For example, the tone mapping module 125 may receive real-time input from the CV model 1001, such as the confidence map including a confidence value and output image from a semantic segmentation network. The tone mapping module 125 may be trained to improve the confidence for the next frame of the same image, without compromising the visual performance.

The balance between improving confidence and visual quality may be controlled by weighting the losses on each component. This weighting may allow for flexibility during training and may serve as a tuning handle. For example, when the tone-mapped output image is not used as a visual output, the tone mapping model may be tuned to prioritize improving the CV task, regardless of the image quality of the tone-mapped output image. For example, as shown in FIG. 10, the tone mapping module 125 may receive the previous frame's confidence output from the CV model 1001, along with the current image. Using this confidence, the tone mapping module 125 may adjust itself to improve the performance of the CV model 1001 on the current image, without affecting the visual quality of the tone-mapped output image.

An example of this is shown in FIG. 10. At inference time, when a frame #N is processed by the tone mapping module 125, the corresponding tone-mapped output image may be fed to the CV model 1001, and one or more confidence values, which may be referred to as a confidence map, may be generated. This confidence map may be denoted as CM[#N].

When frame #N+1 is processed, CM[#N] may be used as another input to the curve prediction module 207 (for example by either calculating the histogram also over CM[#N], or by providing downscaled version of CM[#N] so that the NN size may not increase significantly). In addition, when frame #N+1 is processed, CM[#N] may also serve as another input to the statistics module 204 (or for example by providing a downscaled version of CM[#N] so that the NN size may not increase significantly). Accordingly, because the tone mapping module 125 may be trained to use confidence information, the output tone mapped image may be expected to be enhanced in terms of the task performed by the CV model 1001.

In some embodiments, when performance allows, multiple iterations may be performed for each frame. In this case, when running frame #N for a K^{th} iteration, the tone mapping module 125 may receive as input the confidence map of the previous iteration of the same frame, instead of the confidence map of the previous frame, but embodiments are not limited thereto.

To minimize the performance gap between the a floating-point implementation and a quantized implementation, the tone mapping module 125 according to embodiments may use a piecewise-linear approximation of the sigmoid function, which may be referred to as a kmogmoid function. According to embodiments, initially, during training, the sigmoid function may be used to optimize the learning process. Subsequently, additional training epochs may be conducted using the kmogmoid function instead of the sigmoid function. This switch in functions may allow for fine-tuning of the weights included in one or more neural network models included in the tone mapping module 125 to better accommodate the quantization process.

According to embodiments, the kmogmoid function may be implemented using a LUT for the forward process and using the original sigmoid gradients for the backward process. This may be done to avoid zero gradients that would result from quantizing the sigmoid function using a LUT. The control points for the kmogmoid function may be specifically tailored to align with the hardware constraints and the quantization process.

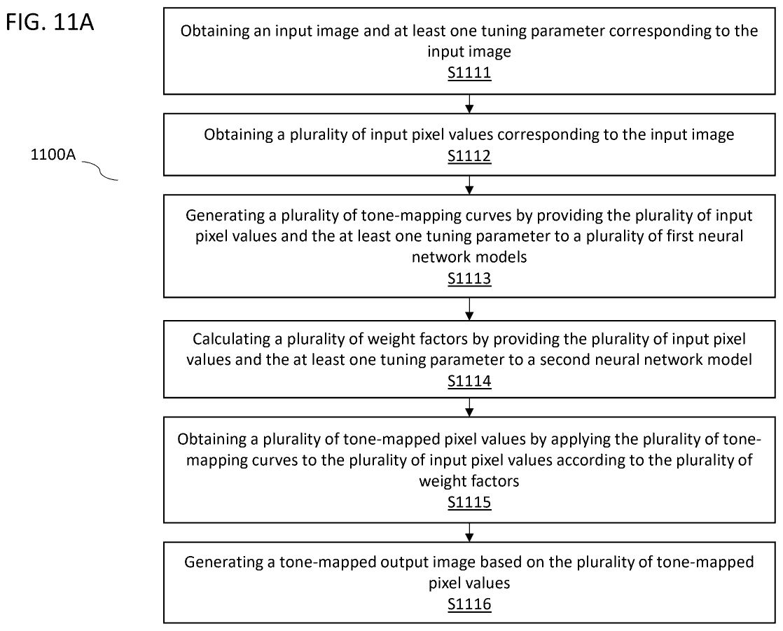

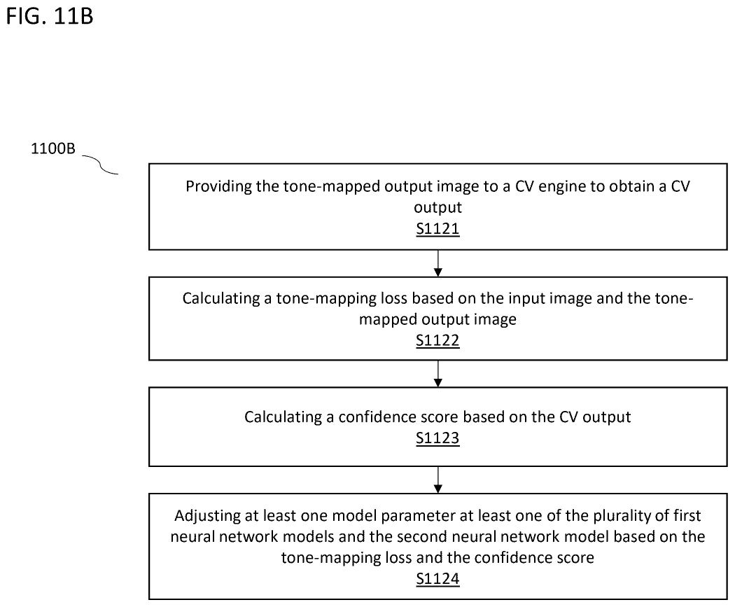

FIG. 11A is a flowchart of an example process for performing tone mapping, according to embodiments. In some implementations, one or more process blocks of FIG. 11A may be performed by any of the elements discussed above, for example one or more of the image processing system 100, the tone mapping module 125, and any of the components included therein.

As shown in FIG. 11A, at operation S1111 the process 1100A may include obtaining an input image and at least one tuning parameter corresponding to the input image. In embodiments, the input image may be an HDR image.

As further shown in FIG. 11A, at operation S1112 the process 1100A may include obtaining a plurality of input pixel values corresponding to the input image. In embodiments, the plurality of input pixel values may correspond to pixel values of the input image, luminance values of the input luminance image, or log-luminance values of the log-luminance image discussed above.

As further shown in FIG. 11A, at operation S1113 the process 1100A may include generating a plurality of tone mapping curves by providing the plurality of input pixel values and the at least one tuning parameter to a plurality of first neural network models. In embodiments, the plurality of first neural network models may correspond to the plurality of curve prediction models 300 included in the curve prediction module 207.

As further shown in FIG. 11A, at operation S1114 the process 1100A may include calculating a plurality of weight factors by providing the plurality of input pixel values and the at least one tuning parameter to a second neural network model. In embodiments, the second neural network model may correspond to the distribution module 205 discussed above.

As further shown in FIG. 11A, at operation S1115 the process 1100A may include obtaining a plurality of tone-mapped pixel values by applying the plurality of tone mapping curves to the plurality of input pixel values according to the plurality of weight factors. In embodiments, the plurality of tone-mapped pixel values may correspond to the tone-mapped pixel values or the tone-mapped luminance values discussed above. In embodiments, the plurality of tone-mapped pixel values may be obtained by the correction module 208 discussed above.

As further shown in FIG. 11A, at operation S1116 the process 1100A may include generating a tone-mapped output image based on the plurality of tone-mapped pixel values. In embodiments, the tone-mapped output image may be generated by the color restoration module 209 discussed above.

In embodiments, a dynamic range of the input image may be greater than a dynamic range of the tone-mapped output image.

In embodiments, the at least one tuning parameter may be used to control at least one of a contrast of the tone-mapped output image and a brightness of the tone-mapped output image.

In embodiments, plurality of tone mapping curves may be represented as a plurality of look-up tables (LUTs).

In embodiments, the plurality of LUTs may include a first LUT corresponding to a first tone mapping curve and a second LUT corresponding to a second tone mapping curve, an input pixel value from among the plurality of input pixel values may correspond to a first tone mapping value included in the first LUT, a second tone mapping value included in the second LUT, and a weight factor included in the plurality of weight factors, and a tone-mapped pixel value corresponding to the input pixel value may be obtained by performing linear interpolation on the first tone mapping value and the second tone mapping value based on the weight factor.

In embodiments, the plurality of tone mapping curves may be generated based on a histogram that may be obtained based on a plurality of luminance values corresponding to the plurality of input pixel values, wherein the plurality of tone-mapped pixel values may be obtained by adjusting the plurality of luminance values based on the plurality of tone mapping curves and the plurality of weight factors, and the tone-mapped output image may be obtained by performing color restoration based on the adjusted plurality of luminance values.

In embodiments, the process 1100A may further include: calculating a tone mapping loss based on the input image and the tone-mapped output image; and adjusting at least one model parameter of at least one of the first neural network model and the second neural network model based on the tone mapping loss.

In embodiments, at least one of the first neural network model and the second neural network model may include a piecewise linear approximation of a sigmoid function.

FIG. 11B is a flowchart of an example process for training at least one neural network model included in a tone mapping module, according to embodiments. In some implementations, one or more process blocks of FIG. 11B may be performed by any of the elements discussed above, for example one or more of the image processing system 100, the tone mapping module 125, the training module 130, and any of the components included therein.

As shown in FIG. 11B, at operation S1121 the process 1100B may include providing the tone-mapped output image to a computer-vision (CV) engine to obtain a CV output. In embodiments, the CV engine may correspond to the CV model 1001 discussed above.

As further shown in FIG. 11B, at operation S1122 the process 1100B may include calculating a tone mapping loss based on the input image and the tone-mapped output image. In embodiments, the tone mapping loss may correspond to the losses discussed above with reference to FIG. 9.

As further shown in FIG. 11B, at operation S1123 the process 1100B may include calculating a confidence score based on the CV output. In embodiments, the CV output may be, for example, the confidence value or confidence map discussed above. In embodiments, the CV output may be provided as input to the at least one of the tone mapping module 125 and the elements included therein, for example the statistics module 204 and the curve prediction module 207, in order to generate a corresponding output. In embodiments, the confidence score may be, for example, a confidence loss that is calculated based on at least one of the CV output and the corresponding output of the tone mapping module 125 generated based on the CV output.

As further shown in FIG. 11B, at operation S1124 the process 1100B may include adjusting at least one model parameter of at least one of the plurality of first neural network models and the second neural network model based on the tone mapping loss and the confidence score.

In some embodiments, the process 1100B may be performed without only one of the losses discussed above. For example, the at least one of the plurality of first neural network models and the second neural network model may be adjusted based only on the tone mapping loss, or only on the confidence score.

Although FIGS. 11A-11B shows example blocks of processes 1100A and 1100B, in some implementations, the processes 1100A and 1100B may include additional blocks, fewer blocks, different blocks, or differently arranged blocks than those depicted in processes 1100A and 1100B. Additionally, or alternatively, two or more of the blocks of the processes 1100A and 1100Bv may be arranged or combined in any order, or performed in parallel.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. A method for performing tone mapping, the method comprising:
obtaining an input image and at least one tuning parameter corresponding to the input image;
obtaining a plurality of input pixel values corresponding to the input image;
generating a plurality of tone mapping curves by providing the plurality of input pixel values and the at least one tuning parameter to a plurality of first neural network models;
calculating a plurality of weight factors by providing the plurality of input pixel values and the at least one tuning parameter to a second neural network model;
obtaining a plurality of tone-mapped pixel values by applying the plurality of tone mapping curves to the plurality of input pixel values according to the plurality of weight factors; and
generating a tone-mapped output image based on the plurality of tone-mapped pixel values.

2. The method of claim 1, wherein a dynamic range of the input image is greater than a dynamic range of the tone-mapped output image.

3. The method of claim 1, wherein the at least one tuning parameter is used to control at least one of a contrast of the tone-mapped output image and a brightness of the tone-mapped output image.

4. The method of claim 1, wherein the plurality of tone mapping curves are represented as a plurality of look-up tables (LUTs).

5. The method of claim 4, wherein the plurality of LUTs comprises a first LUT corresponding to a first tone mapping curve and a second LUT corresponding to a second tone mapping curve,
wherein an input pixel value from among the plurality of input pixel values corresponds to a first tone mapping value included in the first LUT, a second tone mapping value included in the second LUT, and a weight factor included in the plurality of weight factors, and
wherein a tone-mapped pixel value corresponding to the input pixel value is obtained by performing linear interpolation on the first tone mapping value and the second tone mapping value based on the weight factor.

6. The method of claim 1, wherein the plurality of tone mapping curves are generated based on a histogram that is obtained based on a plurality of luminance values corresponding to the plurality of input pixel values,
wherein the plurality of tone-mapped pixel values are obtained by adjusting the plurality of luminance values based on the plurality of tone mapping curves and the plurality of weight factors, and
wherein the tone-mapped output image is obtained by performing color restoration based on the adjusted plurality of luminance values.

7. The method of claim 1, further comprising:
calculating a tone mapping loss based on the input image and the tone-mapped output image; and
adjusting at least one model parameter of at least one of the plurality of first neural network models and the second neural network model based on the tone mapping loss.

8. The method of claim 7, further comprising providing the tone-mapped output image to a computer-vision (CV) engine to obtain a CV output, and calculating a confidence score based on the CV output, and
wherein the at least one of the plurality of first neural network models and the second neural network model are further adjusted based on the confidence score.

9. The method of claim 1, wherein at least one of the plurality of first neural network models and the second neural network model comprises a piecewise linear approximation of a sigmoid function.

10. An electronic device for performing tone mapping, the electronic device comprising:
at least one processor; and
a memory storing instructions which, when executed by the at least one processor, cause the electronic device to:
obtain an input image and at least one tuning parameter corresponding to the input image,
obtain a plurality of input pixel values corresponding to the input image,
generate a plurality of tone mapping curves by providing the plurality of input pixel values and the at least one tuning parameter to a plurality of first neural network models,
calculate a plurality of weight factors by providing the plurality of input pixel values and the at least one tuning parameter to a second neural network model,
obtain a plurality of tone-mapped pixel values by applying the plurality of tone mapping curves to the plurality of input pixel values according to the plurality of weight factors, and
generate a tone-mapped output image based on the plurality of tone-mapped pixel values.

11. The electronic device of claim 10, wherein a dynamic range of the input image is greater than a dynamic range of the tone-mapped output image.

12. The electronic device of claim 10, wherein the at least one tuning parameter is used to control at least one of a contrast of the tone-mapped output image and a brightness of the tone-mapped output image.

13. The electronic device of claim 10, wherein the plurality of tone mapping curves are represented as a plurality of look-up tables (LUTs).

14. The electronic device of claim 13, wherein the plurality of LUTs comprises a first LUT corresponding to a first tone mapping curve and a second LUT corresponding to a second tone mapping curve,
wherein an input pixel value from among the plurality of input pixel values corresponds to a first tone mapping value included in the first LUT, a second tone mapping value included in the second LUT, and a weight factor included in the plurality of weight factors, and
wherein a tone-mapped pixel value corresponding to the input pixel value is obtained by performing linear interpolation on the first tone mapping value and the second tone mapping value based on the weight factor.

15. The electronic device of claim 10, wherein the plurality of tone mapping curves are generated based on a histogram that is obtained based on a plurality of luminance values corresponding to the plurality of input pixel values,
wherein the plurality of tone-mapped pixel values are obtained by adjusting the plurality of luminance values based on the plurality of tone mapping curves and the plurality of weight factors, and
wherein the tone-mapped output image is obtained by performing color restoration based on the adjusted plurality of luminance values.

16. The electronic device of claim 10, wherein the instructions further cause the electronic device to:
calculate a tone mapping loss based on the input image and the tone-mapped output image; and
adjust at least one model parameter of at least one of the plurality of first neural network models and the second neural network model based on the tone mapping loss.

17. The electronic device of claim 16, wherein the instructions further cause the electronic device to provide the tone-mapped output image to a computer-vision (CV) engine to obtain a CV output, and calculate a confidence score based on the CV output, and
wherein the at least one of the plurality of first neural network models and the second neural network model are further adjusted based on the confidence score.

18. The electronic device of claim 10, wherein at least one of the plurality of first neural network models and the second neural network model comprises a piecewise linear approximation of a sigmoid function.

19. A non-transitory computer-readable medium storing instructions which, when executed by at least one processor of an electronic device for performing tone mapping, cause the electronic device to:
obtain an input image and at least one tuning parameter corresponding to the input image,
obtain a plurality of input pixel values corresponding to the input image,
generate a plurality of tone mapping curves by providing the plurality of input pixel values and the at least one tuning parameter to a plurality of first neural network models,
calculate a plurality of weight factors by providing the plurality of input pixel values and the at least one tuning parameter to a second neural network model,
obtain a plurality of tone-mapped pixel values by applying the plurality of tone mapping curves to the plurality of input pixel values according to the plurality of weight factors, and
generate a tone-mapped output image based on the plurality of tone-mapped pixel values.

20. The non-transitory computer-readable medium of claim 19, wherein the instructions further cause the at least one processor to:
provide the tone-mapped output image to a computer-vision (CV) engine to obtain a CV output;
calculate a tone mapping loss based on the input image and the tone-mapped output image;
calculate a confidence score based on the CV output; and
adjust at least one model parameter of at least one of the plurality of first neural network models and the second neural network model based on the tone mapping loss and the confidence score.
